(19) United States
(12) Patent Application Publication
(10) Pub. No.: US 2008/0091647 A1
(43) Pub. Date: Apr. 17, 2008

(54) TOOL AND A METHOD FOR CUSTOMIZING HINT

(75) Inventors: Liang GAO ZHONG, Beijing (CN); Kun Peng Ren, Beijing (CN); Chan-Hua Liu, San Jose, CA (US); You-Chin Fuh, San Jose, CA (US); Ke Wei Wei, Beijing (CN); Wen Yang, Beijing (CN); Bing Jiang Sun, Beijing (CN)

Correspondence Address: SAWYER LAW GROUP LLP, P.O. BOX 51418, PALO ALTO, CA, 94303, US

(73) Assignee: International Business Machines Corporation, Armonk, NY (US)

(21) Appl. No.: 11/766,759

(22) Filed: Jun. 21, 2007

(30) Foreign Application Priority Data
Oct. 11, 2006 (CN) 2006-10142365.3

(51) Int. Cl. G06F 7/00

(52) U.S. Cl. 707/2

(57) ABSTRACT

The application relates to a tool and a method for customizing hint. According to the invention, provided is at least one hint service adapter configured to collect relevant information of different database platforms, validate customized hint on real database platforms and provide feedback, and deploy the customized hint on database platform. Also provided is hint defining means configured to customize hint independently of database platforms, and providing customized hint to the at least one hint service adapter.

### TECHNICAL FIELD

The present application relates to SQL (Structured Query Language) hint mechanism (also called optimization hint) in DBMS (DabaBase Management System), especially to customization of hint, including the validation of a customized hint.

### BACKGROUND ART

Several major DBMS vendors such as IBM, Microsoft, and Oracle support SQL hint mechanism (also called optimization hint, etc.), which provides a way for experienced DBAs (DataBase Administrators) to suggest or require SQL Optimizer to customize certain parts or all of the access plan based on the criteria specified by the DBAs. For example, a user might know that a specific index is more filtering for certain queries and it will be beneficial to them if it is selected. Based on his/her knowledge, the user might want to use SQL hint to direct the Optimizer to use that specific index, regardless of the Optimizer's decision. However, in order to utilize the current SQL hint implementations, it requires significant SQL tuning skill or experience and the whole process including creation/validation/deployment is a very tedious and time-consuming process.

The reasons are:

1. SQL hints are generated in a proprietary manner. For example, to generate hint, a DB2 for z/OS DBA needs to update PLAN_TABLE and set up a special register; an Oracle or SQL Server DBA needs to embed the hints inside each SQL statement text as the comments, and a DB2 for LUW DBA needs to append some XML text in the end of an SQL statement. In today's enterprise's heterogeneous database environment, this greatly increases DBAs' burden since they need to master the details of hint mechanism for each platform.

2. SQL hints need to be specified manually. For very complex queries, e.g. a query containing 100 predicates and 20 tables, it is difficult and tedious for a DBA to make the hint correct.

3. SQL hints need to be validated manually. It is not enough for the hints to be correct in terms of syntax; the hints may be invalid due to conflicts. Although different DBMS provide some feedback on the hint use, they are generally not user friendly.

Apparently, an effective solution is needed to address at least some of the issues mentioned above.

### SUMMARY OF THE INVENTION

Therefore, one object of the invention is to provide a tool for customizing hints, enabling the user to customize hints independently from any platform of databases.

For achieving the object, as one aspect of the invention, a tool for customizing hint is provided, comprising: at least one hint service adapter configured to collect relevant information of different database platforms, validate customized hint on real database platforms and provide feedback, and deploy the customized hint on database platform; and hint defining means configured to customize hint independently of database platforms, and providing customized hint to the at least one hint service adapter.

As another aspect of the invention, a method for customizing hint is provided, comprising steps of: (a) selecting a hint service adapter corresponding to the type of the database platform; (b) analyzing input SQL query to obtain a table join graph and a default table join sequence graph comprising table nodes and nodes of table join method; (c) modifying the join sequence of the tables in the default table join sequence graph to obtain table join sequence graph, and configuring the properties of the tables nodes and nodes of table join method in the default table join sequence graph or table join sequence graph; (d) generating hint according to the result of step c; (e) validating the generated hint in the environment of the database platform through the hint service adapter, if necessary, feeding the validation result back to step c and repeating steps c to e, until desired hint is obtained; and (f) deploying the generated hint into the database platform through the hint service adapter.

### BRIEF DESCRIPTION OF THE DRAWINGS

The invention will be described below in details with reference to the preferred embodiments and the drawings, wherein:

FIG. 1 is a block diagram illustrating a tool for customizing hints according a preferred embodiment of the invention.

FIG. 2 is a block diagram illustrating a tool for customizing hints according another preferred embodiment of the invention.

FIG. 3A is an example of a table join graph.

FIG. 3B is an example of a graph of default table-joining sequence corresponding to the table join graph shown in FIG. 3A.

FIG. 4 is an example of an implementation of defining the properties of nodes.

FIG. 5 is a flow chart illustrating a method for customizing hints according a preferred embodiment of the invention.

FIG. 6 is a flow chart illustrating a method for customizing hints according another preferred embodiment of the invention.

### DETAILED DESCRIPTION OF THE PREFERRED EMBODIMENTS

The main object of the invention aims to eliminate the necessity of customizing hints for each different database platforms. To this end, the application proposes a new solution, that is, providing SQL query-based versatile hint defining means and a hint service adapter (herein after referred to as “the adapter”) serving as an intermediate between the database platforms and the hint defining means, for validating hints defined by the hint defining means on the database platforms and deploying the validated hints on the database platforms.

A different platform needs a different adapter. In an embodiment of the invention, different adapters may be provided for different database platforms and be selected by a DBA according to the database platform in use.

For further facilitating the DBA, a selector may be provided for detecting relevant information of a database platform to determine the type and version of the database platform and thus select an appropriate adapter.

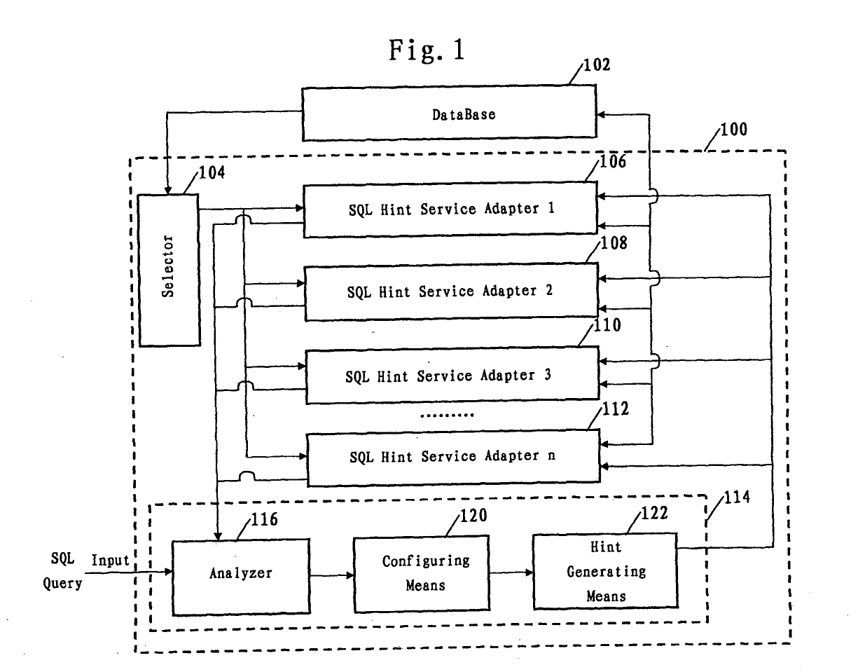

FIG. 1 illustrates a tool 100 for customizing hints according to the preferred embodiment. As shown in the drawing, there are a plurality of adapters 106, 108, 110 and 112, each corresponding to a database platform. A selector 104 is configured to select an appropriate adapter according to the type and version of the database obtained from the database 102. A DBA uses hint defining means 114 to customize hints based in input SQL, validates the hints on a real database platform through the adapter, and deploys the validated hints onto the database platform.

As a more preferred embodiment, the hint defining means 114 of the hint customizing tool 100 as shown in FIG. 1 may further comprise an analyzer 116, configuring means 120 and hint generating means 122. The analyzer 116 analyzes an input SQL query and obtains a table join graph and a graph of default table-joining sequence with reference to the system information of the database platform from the adapter. Based on the data obtained by analyzing the SQL query, all the tables involved in the execution of the SQL query and the relations among the tables may be extracted. Based on the system information of the database platform obtained from the database, further relevant information may be obtained, such as columns and indices as defined in a table, statistic information and the like. A graph of table-joining sequence represents a sequence in which the tables are accessed during the execution of the SQL query. The table-joining sequence may be any sequence complying with the logic of the table join graph. However, the table-joining sequence may be made an optimal sequence complying with the logic of the table join graph. Furthermore, the sequence may be constrained by the query history and the hints defined before, and thus a default table-joining sequence graph is obtained.

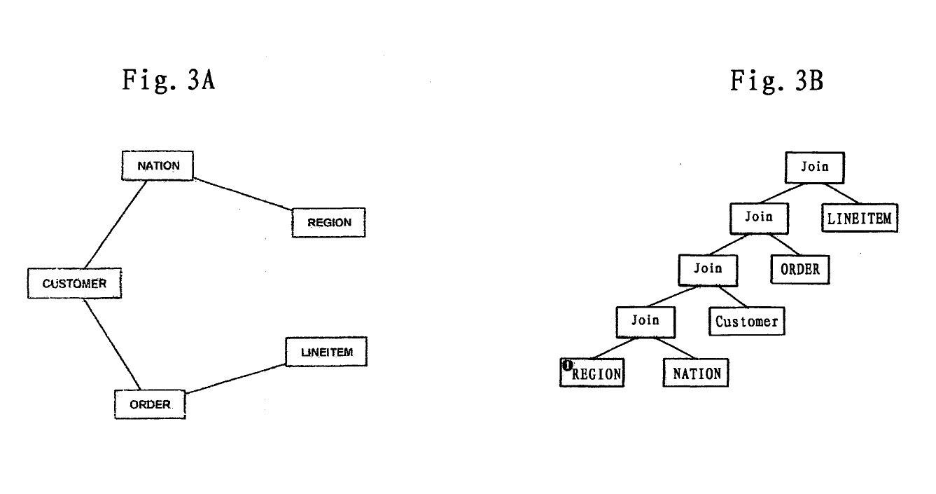

The table join graph and the default table-joining sequence graph may be displayed visually on a graphic user interface (GUI). As shown in FIG. 3A, each box-like node represents a table. A line between two boxes represents a fact that the two boxes are interrelated and corresponds to a predicate in a query. The graph in FIG. 3A shows how the tables involved in a query are joined to each other. A table join graph not only shows how the tables involved in a query are joined to each other, but also contains the properties of the solution as originally stored. In an initial state, an automatic layout of the table join graph may be provided for improving the visual experience of a user, who may re-arrange the layout manually through drag-and-drop operations. On the join graph, two triggers are provided by visual plan hint, they enable user to show local predicates and join predicates.

FIG. 3B shows a default table-joining sequence graph based on the table join graph shown in FIG. 3A. In FIG. 3B, the sequence in which the respective tables are arranged on the GUI is just the sequence in which the tables are joined together. A node connecting two tables represents a join method. A user can infer from the table join graph shown in FIG. 3A in which order the joining is the most efficient. A default join sequence is the join sequence determined by Database Optimizer without using hints. By adjusting the default join sequence, the user can produce his/her own join sequence easily.

Configuring means 120 may modify a table-joining sequence graph as shown in FIG. 3B. For example, a table-joining sequence graph may be modified by drag-and-dropping a table to an appropriate position in the table-joining sequence graph as shown in FIG. 3B. When a user defines his/her own table-joining sequence graph, the nodes already used may be highlighted and leading table auto-checking may be conducted, so as to assist the user's defining.

In general, a hint may further contain the following contents in addition to the table-joining sequence:

1. How a table is accessed, for example, it can tell whether index access or r-scan is preferred, which index is to be used, and whether list-prefetch should be used or not, etc.

2. Table-joining method in multi table access.

3. Parallelism such as parallel mode and parallel degree.

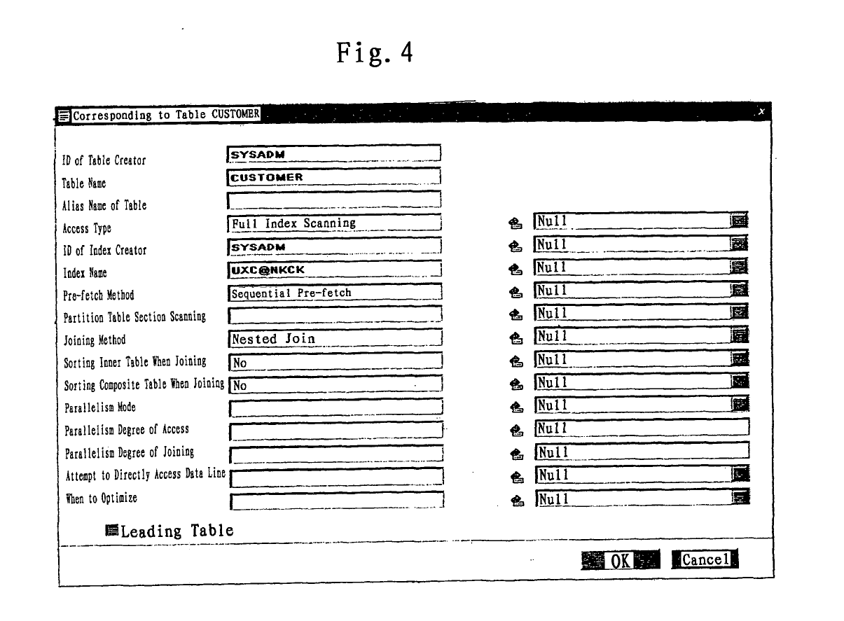

These hint contents may be regarded as the properties of a table node or a joining-method node. According to a preferred embodiment, the configuring means 120 may be designed so as to pop out a dialog window as shown in FIG. 4 when a table node or a joining-method node is selected to be configured. In the dialog window, relevant properties may be filled in or selected. Specifically, for a platform such as DB2 for z/OS, there may be properties as shown in the table below.

TABLE 1
EXAMPLES OF PROPERTIES OF A TABLE NODE OR A JOINING-METHOD NODE

| | |
|---|---|
| Properties to be set | Description |

1. Defining the method of accessing a table (properties of a table node)

| | | |
|---|---|---|
| 1.1 Determining a table to be | CREATOR | ID of the creator of a table, to be set when |
| defined. To determine the tables | | TNAME can not uniquely identify a table |
| to be defined in a hint, the | | to be defined. |
| following properties are used to | TNAME | Name of a table. It may also be a name of |
| uniquely identify the tables. | | a view or a name of an expression. |
| | TABNO | Number of a table, to be set when setting |
| | | CREATOR, TNAM, |
| | | CORRELATION_NAME and |
| | | QBLOCKNO can not uniquely identify a |
| | | table to be defined. |
| | CORRELATION_NAME | Alias name of a table in SQL |
| | QBLOCKNO | Query block in which a table is located in |
| | | a stored access plan. |
| 1.2 Defining an access type of a | ACCESSTYPE | Valid values must be I, I1, N, M, R, RW, |
| table, and a method by which a | | T, or V₀ |
| database engine access the table. | | |
| For example, the property set as | | |
| “I” indicates the table is to be | | |
| accessed using all-index | | |
| scanning, and the property set as | | |
| “R” indicates the table is to be | | |
| accessed using all-table scanning. | | |
| 1.3 Defining indices used when | ACCESSCREATOR | ID of the creator of an index. |
| being accessed. However, when | | |
| the table-accessing method as | ACCESSNAME | Name of an index |
| defined in 1.2 is index scanning, | | |
| a user may define the following | | |
| two properties to appoint the | | |
| indices to be used in index | | |
| scanning. | | |
| 1.4 Defining pre-fetch method | PREFETCH | Valid values must be S, L or blank; |
| | | The value defines the pre-fetch method |
| | | used by DB2: |
| | | sequential prefetch (S) |
| | | list prefetch (L) |
| | | no prefetch (blank) |
| 1.5 Defining whether a data | PAGE_RANGE | Valid values must be Y, N or blank |
| scanning is limited in one or | | |
| more certain partition table | | |
| spaces | | |
| 1.6 Defining whether a table | PRIMARY_ACCESSTYPE | Valid values must be D or blank |
| access attempts to conduct | | D: Attempt to conduct direct access using |
| direct access using data line | | data line |
| | | Blank: Not attempt to conduct direct |
| | | access using data line |

2. Table joining in multiple-table access (Properties of Joining-Method Node)

| | | |
|---|---|---|
| 2.1 Appointing | METHOD | Valid values must be 0, 1, 2, 3, or 4. |
| table-joining method | | 0: The table to be accessed first (leading table) |
| | | 1: Nested loop join |
| | | 2: Merge scan join |
| | | 3: ORDER BY, GROUP BY, SELECT |
| | | DISTINCT, UNION, sorting as needed |
| | | 4: Hybrid join |
| 2.2 Joining sequence of | PLANNO | For one query block, using sequential numbers to |
| multiple tables | | represent the joining sequence of tables. |
| 2.3 About sorting in table | SORTN_Join | Valid values must be Y, N, whether the inner |
| joining | | tables shall be sorted during joining |
| | SORTC_Join | Valid values must be Y, N, whether the composite |
| | | tables shall be sorted during joining |

3. Parallelism (Properties of a Joining-Method Node)

| | | |
|---|---|---|
| 3.1 Stipulating | PARALLELISM_MODE | Appointing a parallelism mode to be used. If |
| parallelism mode | | parallel access is allowed, then the valid value is |
| | | I, C, X or blank. |
| 3.2 Stipulating | ACCESS_DEGREE | Number of parallel tasks |
| parallelism degree of | | |
| table accessing | | |
| 3.2 Stipulating | JOIN_DEGREE | Number of parallel tasks when joining inner |
| parallelism degree of | | tables and composite tables. |
| table joining | | |

The joining sequence of multiple tables shown in 2.2 in above table may be determined by directly drag-and-dropping table nodes. However, the sequence property may also be displayed in a dialog box relating to the properties of a node and its value may be modified so that the joining sequence may be changed.

It is to be noted that the properties shown above are just illustrative examples. In practice of the invention, properties may be included as many as those potentially involved in all database platforms. And, when displaying a property dialog box, the property dialog box may be customized according to the type or version of the database platform determined by the selector or appointed by the DBA, so that unnecessary property options may be masked.

To assistant user to define plan hint criteria, the following features may be provided in the GUI:

1. Provide the existing access plan information to help user to decide the hint criteria.

2. Show changeable hints and hide those non-changeable hints.

3. Show local predicates and join predicates on the join graph to help user to decide the hint criteria.

When the configuration of respective nodes has been completed, the hint generating means 122 may generate a hint. That is, the customization information is finally transformed into the internal hint definition criteria which are the abstract of hint definition. Because the internal hint definition criteria is independent of database's platform and hint type. It can be used to generate the hints for any database platform and any hint type automatically. At the same time, it also let user get rid of typos and syntax errors which are mentioned above.

The adapter validates the generated hints in a real database platform environment and finally gives validation report to user. From the report, user can know:

1. Which parts of the hints are used by database optimizer.

2. Which parts of the hints are not used and why they are not used. For these hints, it can also give some advice.

3. What's the difference in the access path.

Finally, the adapter deploys validated hints into the database platform. The deployment means the hints generated in the hint generating means 114 are added into respective database platform in a manner specific to respective database platform.

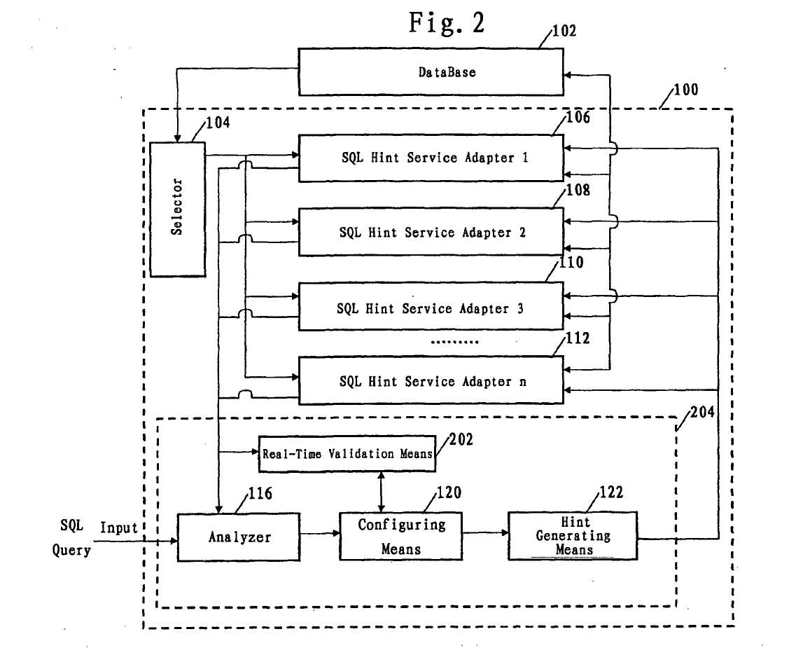

FIG. 2 shows a hint customization tool according to another preferred embodiment of the invention. The embodiment is substantially the same as that shown in FIG. 1, except that real-time validation means 202 is added in the hint defining means 204 (corresponding to the hint defining means 114 in FIG. 1). The real-time validation means 202 provides client-side runtime validation for semantic error and conflicts in the hints being defined by the user through the configuring means 120. Those errors, when happening, may be highlighted and corresponding advices may be given.

According to a more preferred embodiment, for reducing the time consumed by the validation performed by the adapter in real database platform environment, those hints that are being defined may be validated in real time with further reference to information about the database platform collected and provided by the adapter. Although such real-time validation could not replace completely the functions of the validation in a real database platform environment, it could realize most of the functions of the latter, and thus remarkably reduce the time consumed in validation.

In the preferred embodiment discussed above, if the relevant information about a database is already known to the hint customization tool according to the invention, for example, if the hint customization tool ever collected relevant information of the database, which has not been changed thereafter, then it is unnecessary for the hint customization tool to be connected to the database. Contrariwise, it is necessary for the database to be connected to the database to obtain relevant information.

A hint customization tool according to the invention has been described above. For understanding the respective components of the hint customization tool, further reference may be made to the following detailed description of the corresponding hint customization method.

A hint customization method corresponding to the hint customization tool described above will be discussed below.

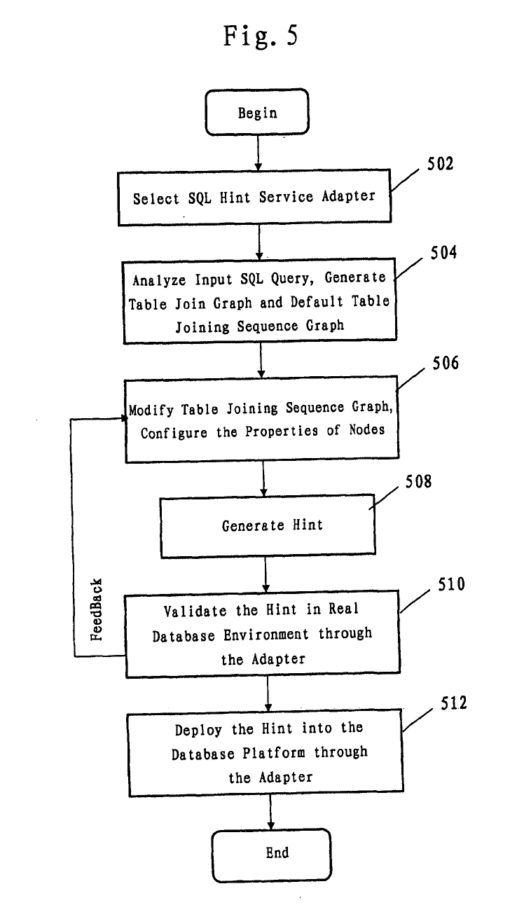

FIG. 5 shows a hint customization method according to a preferred embodiment of the invention. Firstly, a SQL hint service adapter to be loaded is determined (Step 502), so that further processing may be performed, such as loading catalog information; collecting related data from specific database to generate join graph and default join sequence graph etc. SQL hint service adaptor is a mechanism provided by this invention, which can shield the difference of platform. The different adaptor is applied on the different database platform. For the adapter, reference may also be made to the description with reference to FIG. 1.

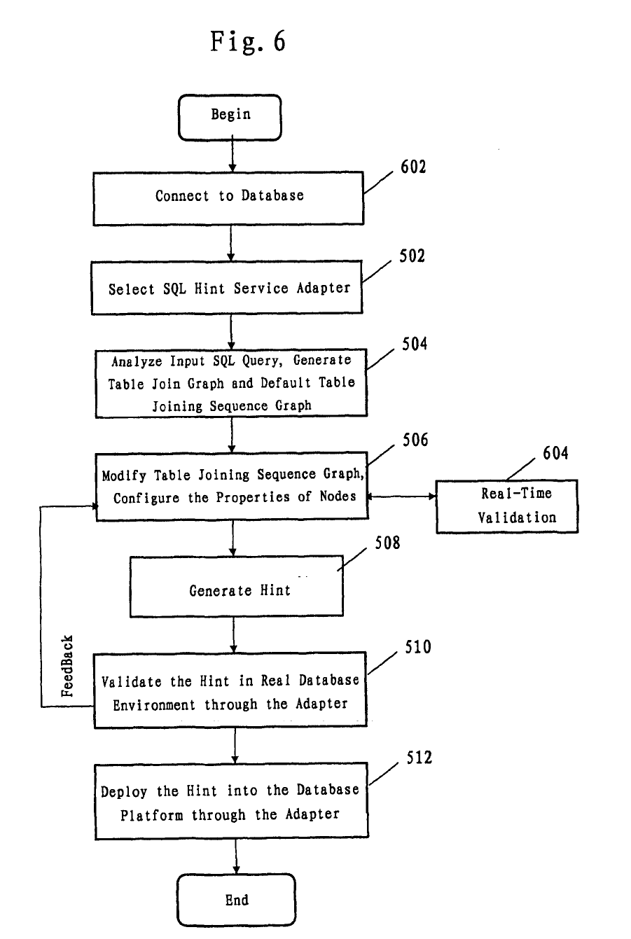

Similarly, as in the hint customization tool as described above, if the relevant information about a database is known, then it is unnecessary to connect the database when performing the method according to the invention. If the case is contrary, then it is necessary to connect to the database firstly to check the information about the platform and version of the database (Step 602 in FIG. 6), so as to determine an adapter based on the information.

Then, in Step 504, the input SQL statement will be analyzed to generate the join graph and the following information will be collected:
Catalog information from the database.
The related information about the current access path chosen by the database engine and reorganize them into a common data model which will be used to generate join graph and default join sequence graph. According to the invention, a node in a table join graph or a default table joining sequence graph carries a set of customizable properties.
Load platform dependent knowledge-based hint configuration and validation rule from the repository, which will be used to validate platform dependent hint.

With the required information collected correctly, a table join graph and a default table joining sequence graph independent of platform may be constructed.

Then, in Step 506, the user can customize the SQL hints based on the table join graph and default table joining sequence graph. For example, in the intra-table level, he/she can customize table access method, indexes used, etc; in the inter-table level, he/she can define join orders between tables, join method, etc. For specific customization, reference may be made to the description about the configuring means 120.

After user finishes customization of a hint, then a SQL hint is generated (Step 508). SQL hints are sent though the adapter to the database engine side for validation (Step 510). Then a feedback is obtained, such as a SQL hint validation report. The hint validation report may help a user to know the following things:

1. The generated optimization hint according to the user's definition criteria and selected hint type.

2. The difference between the old access plan without using plan hint and the new plan using the generated hint. Visual Plan Hint will highlight them.

3. Which parts in the hints has taken effective.

4. Which parts in the hints are invalid/unused and why those parts are not used and also give the corresponding advices.

If a user does not satisfy the current result according to the feedback, the user may further modify the table joining sequence graph and configure the properties of nodes, so as to re-define the hints and re-validate the hints until the result is satisfying.

If the SQL hints generated from the definition of the user are just what the user wants, then the customized hints may be deployed to the database platform through the adapter (Step 512), so that other applications may use the hints. Since the hint customization process is independent of the specific database platform and hint type, it can be deployed to any database with any hint type. User just needs to define the hints just once.

In a more preferred embodiment, as shown in FIG. 6, the hints being defined may be validated in real time at same time when modifying the table joining sequence graph and configuring the properties of the nodes. If any errors or warnings are found, the related hints will be pointed out and the corresponding advices will be provided in real time. In general, the hint validation can be divided into two categories:
One is generic validation, which is based on a common validation rule set, can be applied to all kinds of database platforms and is independent of any specific platform. It includes:
Database schema related validation. Database schema is the common definition on all kinds of database platforms. Taking the index definition which belongs to database schema as an example, if no index exists on a particular table in the SQL statement, the index scan hint can not be applied on this table.
SQL statement related validation. SQL is also the common standard for all kinds of database platforms. For example, if no column of an index on a table comes up in the SQL statement and the SQL doesn't intend to count the total number of records on the table, the hint using the index on the SQL statement is inefficient.
Conflict detection in defined hints. For an instance, a hint using index scan on a table is added, but there is an earlier hint which requires the table is accessed with table scan, it is a conflicting; intelligent circle loop detection on table reference join sequence defined by the user is another example here, etc.

The other is platform dependent validation. For those platform dependent SQL hints, they are validated through rule engine-based driven methods. These knowledge-based rules are constructed loaded by the SQL hint service adapter as mentioned above for different platform types. For example, for DB2 for z/OS platform, hybrid join requires the inner table being accessed by index-based list prefetch.

Now preferred embodiments of the hint customization tool and method according to the invention have been described. From above it could be seen that the invention has the following advantages:

1. Independent of specific database platform. User does not need to master the details of hints mechanism for each platform and greatly reduce DBAs' burden.

2. Enables users to define/validate/deploy optimization hints visually and make use of hints easier, provides runtime validation and expert advices and free user from the implied semantic errors and conflicts.

3. Based on graphical interface, user can define much more complex optimization hint.

A person skilled in the art will understand that there are many alternatives to the components and steps described above. Therefore, the protection scope of the invention shall not be limited to the specific details in the description, but shall be construed as encompassing all equivalents.

What is claimed:

1. A tool for customizing a hint, comprising:
at least one hint service adapter configured to collect relevant information of different database platforms, validate customized hint on real database platforms and provide feedback, and deploy the customized hint on database platform; and
hint defining means configured to customize hint independently of database platforms, and providing customized hint to the at least one hint service adapter.

2. The tool for customizing a hint according to claim 1, further comprising a selector configured to analyze the type of a database platform when the tool is connected to the database platform, and select a corresponding hint service adapter.

3. The tool for customizing a hint according to claim 1, wherein the hint defining means comprises:
an analyzer configured to analyze an input SQL query and thus obtain a table join graph and a default table joining sequence graph, which comprises table nodes and table joining method nodes;
configuring means configured to modify the joining sequence of tables in the default table joining sequence graph to obtain a table joining sequence graph, and configure the properties of the table nodes and table joining sequence method nodes in the default table joining sequence graph or table joining sequence graph; and
hint generating means configured to generate a hint according to the results of the analyzer and the configuring means.

4. The tool for customizing a hint according to claim 1, further comprising real-time validation means, configured to validate in real time the hint to be generated based on relevant information about the database platform provided by a corresponding hint service adapter during the modifying and configuring process of the configuring means, and provide feed-back.

5. The method for customizing a hint according to claim 2, further comprising real-time validation means, configured to validate in real time the hint to be generated based on relevant information about the database platform provided by a corresponding hint service adapter during the modifying and configuring process of the configuring means, and provide feed-back.

6. The method for customizing a hint according to claim 3, further comprising real-time validation means, configured to validate in real time the hint to be generated based on relevant information about the database platform provided by a corresponding hint service adapter during the modifying and configuring process of the configuring means, and provide feed-back.

7. The method for customizing a hint according to claim 2, wherein the hint defining means comprises:
an analyzer configured to analyze an input SQL query and thus obtain a table join graph and a default table joining sequence graph, which comprises table nodes and table joining method nodes;
configuring means configured to modify the joining sequence of tables in the default table joining sequence graph to obtain a table joining sequence graph, and configure the properties of the table nodes and table joining sequence method nodes in the default table joining sequence graph or table joining sequence graph; and
hint generating means configured to generate a hint according to the results of the analyzer and the configuring means.

8. A method for customizing a hint, comprising:
selecting a hint service adapter corresponding to the type of the database platform;
analyzing input SQL query to obtain a table join graph and a default table join sequence graph comprising table nodes and nodes of a table join method;
modifying the join sequence of the tables in the default table join sequence graph to obtain a table join sequence graph, and configuring the properties of the tables nodes and nodes of table join method in the default table join sequence graph or table join sequence graph;
generating hint according to the result of modifying the join sequence;
validating the generated hint in the environment of the database platform through the hint service adapter, if necessary, feeding the validation result back to modifying the join sequence and repeating modifying the join sequence, generating hint and validating the generated hint, until desired hint is obtained;
deploying the generated hint into the database platform through the hint service adapter.

9. The method for customizing a hint according to claim 8, further comprising, before the selecting a hint service adapter of connecting to a database platform and analyzing the type of the database platform, wherein, in selecting a hint service adapter, a corresponding hint service adapter is selected based on the result of the step.

10. The method for customizing a hint according to claim 8, further comprising a step of real-time validation of modifying the join sequence, configured to validate in real time the modifying and configuring operations in modifying the join sequence according to relevant information about the database platform provided by the hint service adapter, provide feed-back, and repeat modifying the join sequence according to the feed-back.

11. The method for customizing a hint according to claim 8, further comprising a step of real-time validation of modifying the join sequence, configured to validate in real time the modifying and configuring operations in modifying the join sequence according to relevant information about the database platform provided by the hint service adapter, provide feed-back, and repeat modifying the join sequence according to the feed-back.
